(19) United States
(12) Patent Application Publication
(10) Pub. No.: US 2021/0260913 A1
(43) Pub. Date: Aug. 26, 2021

(54) METHOD FOR DECORATING A SURFACE, AND RELATED DECAL

(71) Applicant: G.DECAL S.R.L. SEMPLIFICATA, Frazione Osteria Grande (IT)

(72) Inventor: Michele MUNARI, Castel San Pietro Terme (IT)

(21) Appl. No.: 17/048,843

(22) PCT Filed: Apr. 18, 2019
(86) PCT No.: PCT/IB2019/053219

§ 371 Date: Oct. 19, 2020

(30) Foreign Application Priority Data
Apr. 19, 2018 (IT) 102018000004692

(51) Int. Cl. B44C 1/175; B41M 3/12

(52) U.S. Cl. CPC B44C 1/1758; B41M 3/12

(57) ABSTRACT

A method for decorating a surface, in order to apply a predefined image to a destination surface, includes the steps of
a) preparing a base sheet, which contains an adhesive,
b) reproducing the predefined image on the base sheet,
c) applying a backing film to the predefined image, and
d) covering the backing film with an additional stiffening film, which is adapted to increase the rigidity of the predefined image and/or of the backing film.

The method further includes the steps of e) wetting the decal, in order to allow the transfer of the adhesive toward the predefined image,
f) applying the decal to the destination surface, by bringing the base sheet into contact with the destination surface,
g) sliding away the base sheet, while keeping the predefined image positioned on the surface, and
h) removing the backing film and the film.

### TECHNICAL FIELD

The present disclosure relates to a method for decorating a surface, and a related decal.

### BACKGROUND

As is known, the term “decal” identifies a particular decoration technique, which involves the transfer of an image of interest from a temporary sheet (of waterslide paper or other suitable material) to a destination surface, which one wants to decorate. The term is also used to define the image itself and/or the assembly of the image and of the sheet with any other accessory elements.

According to one of the various operating methods now widespread (“water decal”), the image is first printed (by screen printing or lithography for example) on the sheet, to which an adhesive (normally dextrin) has previously been added.

After having printed or otherwise applied a film (typically based on collodion) onto the image in order to ensure its correct positioning, the assembly thus obtained (the decal) is soaked in hot or tepid water (in order to facilitate the transfer of the adhesive to the image), and deposited on the destination surface.

The method then entails removing the temporary sheet, by making it slip and slide along the surface and then slipping it out from underneath the image, while bringing the latter into direct contact with the destination surface.

Finally, the decoration is completed by allowing the image to rest (usually for 12-24 hours), allowing the adhesive to fully take and to dry, and then removing the upper film.

The technique described above therefore has application in the automotive sector, for decorating vehicle bodywork, but it is also used for bicycles and motorcycles, as with other objects to be decorated, of various different types and in different sectors.

Such decoration technique is not however devoid of drawbacks.

As can be readily understood, the step of removing the sheet is the most delicate moment of the entire process: it is in fact necessary to take the greatest care during the sliding in order to prevent the image and the upper film from being subjected to even the minimum of stresses, which could still cause a deformation of the material and therefore of the image.

In fact a small stretching or a slight wrinkle is sufficient to irretrievably compromise the quality of the work, resulting in an image being applied on the destination surface that is deformed or which contains wrinkles or folds, evidently with an aesthetic result that is completely unwelcome and often unacceptable.

This entails the need to execute the step of removal/extraction extremely slowly and in any case availing of highly qualified personnel: this implies labor costs and times that are excessive and which nowadays are incompatible with the needs of mass production (consider for example the attention to costs and to cycle times in the automotive sector, which, as seen, constitutes the preferred application of the technique explained herein).

Moreover, even if the precautions described above are adopted, it is in any case not possible to reduce defects below a significant percentage, which is inherent in the removal technique itself.

### SUMMARY

The aim of the present disclosure is to solve the above mentioned problems, by providing a method for decorating surfaces that can be carried out rapidly and easily, eliminating or at least appreciably reducing the risk of defects on the decoration obtained.

Within this aim, the disclosure provides a decal that can be applied on a destination surface rapidly and easily, eliminating or at least appreciably reducing the risk of defects.

The disclosure provides a method that can be carried out reliably by even unqualified personnel.

The disclosure provides a decal that ensures a high reliability of operation.

The disclosure provides a decal that adopts an alternative technical and structural architecture to those of conventional solutions.

The disclosure provides a decal that can be easily implemented using elements and materials that are readily available on the market and at low cost.

This aim and these and other advantages which will become better apparent hereinafter are achieved by providing the method according to claim 1, by a decal according to claim 6, and by the use of such decal according to claim 10.

### BRIEF DESCRIPTION OF THE DRAWINGS

Further characteristics and advantages of the disclosure will become better apparent from the description of a preferred, but not exclusive, embodiment of the method and of the decal according to the disclosure, which are illustrated by way of non-limiting example in the accompanying drawings wherein:

FIG. 1 is a block diagram of the method according to the disclosure; and

FIG. 2 is a schematic perspective view of the decal according to the disclosure.

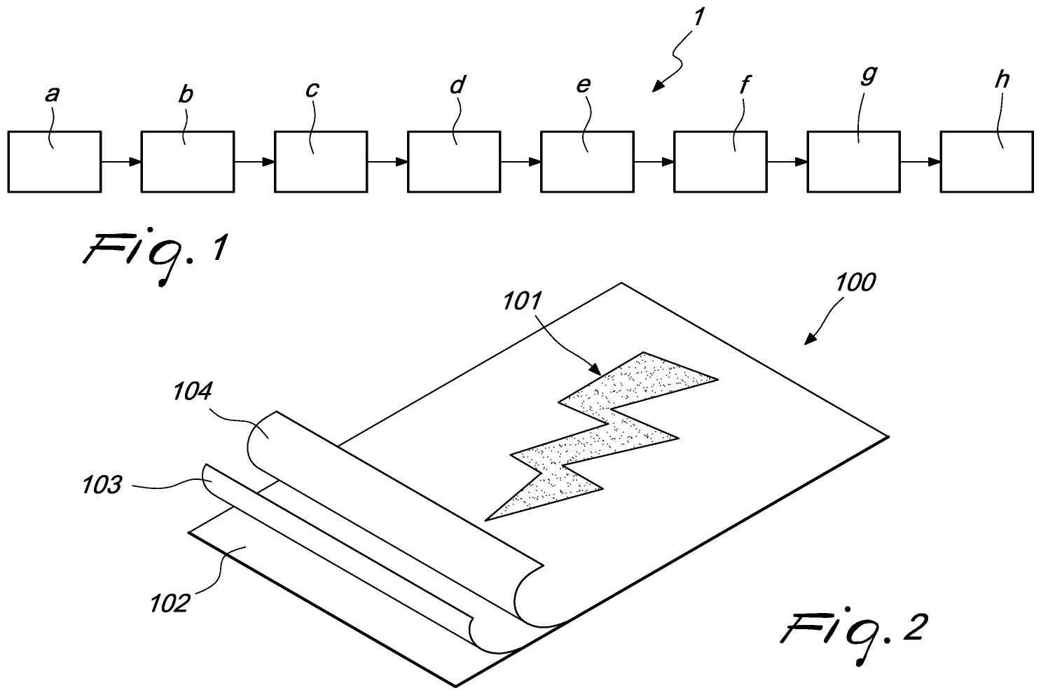

### DETAILED DESCRIPTION OF THE DRAWINGS

With reference to the figures, the reference numeral 1 generally designates a method for decorating a surface.

It should be noted from this point onward that the present disclosure, in addition to the method 1, provides a decal 100 that can be obtained at the end of an intermediate step of the method 1 (as will become better apparent below) and which can in fact be used to decorate a surface, in implementation of the method 1.

In more detail, the method 1 can be carried out in order to affix an image 101 on a destination surface.

As will be better explained in the following pages, the term decal 100 will be used to define a form of sheet-like element with several layers (one of which is in fact constituted by the image 101), obtained within the scope of the method 1 and used to decorate the destination surface.

In the preferred application, which is to be considered as a non-limiting example, the destination surface belongs to the body of a motor vehicle (be it a car, a coach, a truck, an articulated lorry etc.), and therefore can be constituted for example by the hood or by a door.

The destination surface can in any case be defined by the frame of a motorcycle, of a bicycle, of agricultural machinery, by the hull of a watercraft, or by any other object (a helmet for example).

More generally, it should be noted from this point onward that the destination surface can be any (as incidentally can be the subject matter depicted in the image 101), without for this reason falling outside the scope of protection.

The method 1 entails, in a step a), preparing a base sheet 102 which contains an adhesive.

The base sheet 102 adapted in step a) can for example comprise a sheet of waterslide paper (which may be of a commercial type), to which the adhesive is added, which is constituted (preferably but not exclusively) by dextrin. The dextrin, which as is known is a dry starch gum, can for example be spread on the sheet of paper. In any case, the adhesive (be it dextrin or another adhesive) has the function of anchoring the image 101 to the destination surface.

It should be noted that step a) can be carried out by simply providing one or more sheets of waterslide paper that are already available on the market, which are sold by makers with dextrin (or another adhesive) already added.

Subsequently, in a step b), the method 1 according to the disclosure entails reproducing the predefined image 101 on the base sheet 102.

Typically, step b) is obtained by printing, more particularly by screen printing or lithography, although different practical choices are not ruled out. The image 101 may or may not be in color and can be made for example with paints of various types. In any case, it can be constituted by an elaborate pattern or by a simpler geometric shape, evidently as a function of the specific decoration that it is desired to provide on the destination surface.

After step b), the method 1 according to the disclosure entails, in a step c), applying a backing film 103 to the image 101, which ensures the subsequent retention of the correct positioning of the image 101 (as will become better apparent below).

In particular, in an implementation of significant practical interest, but which does not limit the application of the disclosure, step c) of the method 1 according to the disclosure entails applying (by printing or in another manner) a backing film 103 to the image 101, which is constituted by a transparent material (but it may also be at least partially opaque) based on collodion. The material chosen for the backing film 103 is preferably of the easy-peel-away type.

In such context, it may be sufficient to use a few microns of such backing film 103 (a sort of detaching paint) in order to obtain the result just described. In general, however, the thickness of the backing film 103 (as with the thickness of the base sheet 102 and of any other layer of the decal 100), can be any, according to the specific requirements.

Subsequently, in a step d) the method 1 according to the disclosure entails coating the backing film 103 with an additional stiffening film 104.

The film 104 is adapted to increase the rigidity of the image 101 and/or of the backing film 103, so as to guard against (or at least reduce) the danger that in the subsequent steps deformations, wrinkles or stretches could occur which are such as to compromise the quality of the decoration carried out.

It should therefore be noted that “rigidity” means precisely the capacity to withstand stresses that otherwise could cause breaks, stretches or deformations, even minimal, but still such as to compromise the integrity of the image 101.

The film 104 can be continuous, perforated or micro-perforated (or another type), according to the specific requirements.

It should be noted that the (multilayer) assembly composed of the base sheet 102, the image 101 (arranged on the base sheet 102), the backing film 103 (arranged on the image 101) and the stiffening film 104 (arranged on the backing film 103) defines the decal 100. Such decal 100 can be independently sold in order to make it possible, even some considerable time after its production, to obtain the desired decoration of the destination surface.

In more detail, it can be observed that steps from a) to d) of the method 1 according to the disclosure can be used to provide the decal 100 according to the disclosure, while the subsequent steps, described in the following pages, make it possible to use the decal 100 to decorate the destination surface with the image 101.

It should likewise be noted that the possibility exists (shown in the accompanying FIG. 2) that the sheet 102, the film 103 and the film 104 have the same shape and dimensions (width and length), with the image 101 having any shape and also dimensions smaller than those of the other components just described, therefore being reproduced on only a portion of the base sheet 102.

Likewise, the film 103 can also be limited to covering the image 101, or in any case to having dimensions smaller than those of the sheet 102 (and of the film 104).

The protection claimed herein should be understood as being extended to any combination of shape and dimensions, for each one of the components described herein.

In particular, in the preferred but not exclusive implementation, step d) entails coating the backing film 103 with an additional stiffening film 104 which is made of a polymeric material. Even more specifically, the film 104 is made of a polymeric material selected from among polyethylene, polyester, polyvinyl chloride and polyurethane.

Conveniently, step d) is obtained by hot or cold calendering; in this case too, however, the possibility is not ruled out of coupling the film 104 to the backing film 103 in another way, while remaining within the scope of protection claimed herein.

Moreover, to ensure the coupling of the film 104 to the backing film 103, both permanent and removable will be used, or other contrivances and aids.

After having completed step d), the method 1 according to the disclosure entails, in a step e), wetting the decal 100, in order to allow the transfer of the adhesive to the image 101 (the adhesive will enable the subsequent adhesion of the image 101 to the destination surface, as will be seen below).

Step e) can for example be carried out by immersing the decal 100 in hot or tepid water, and waiting a few seconds in order to allow to the dextrin (or other adhesive used) to absorb the water.

The method 1 according to the disclosure entails, in a step f), applying the decal 100 to the destination surface, by bringing the base sheet 102 into contact with it. It should be noted that preferably step f) will be carried out after step e) but the possibility is not ruled out, in some contexts and for specific practical requirements, of wetting the decal 100, step e), after having applied it to the destination surface, step f), thus inverting the chronological order of execution of such steps.

Note that in step f) care needs to be taken to apply the decal 100 so that the image 101 (albeit with the interposition of the base sheet 102) is in the exact placement that it is desired to obtain at the end of the decoration.

Subsequently, the method 1 according to the disclosure entails, in a step g), sliding away the base sheet 102, while keeping the image 101 positioned on the surface. In step g) the image 101 is still kept coupled to the backing film 103, which therefore ensures the correct positioning of the image 101 is held.

It should be noted that the extraction entails sliding the base sheet 102 over the destination surface and under the image 101, the backing film 103 and the film 104, which must be kept immobile. The sliding is aided by the wetting carried out in step e).

The presence of the film 104 ensures the achievement of the set aim. In fact, differently from what occurs when using conventional techniques, during the execution of the delicate step g) the risk of deformations, stretches, cracks or even breakage of the image 101 and of the backing film 103 is eliminated or at least appreciably reduced due to the greater rigidity conferred on the latter by this film 104.

After having removed/slid out the base sheet 102 therefore, the image 101 will be in direct contact with the destination surface and the dextrin (or other adhesive) ensures the stable application to that surface, which preferably will in turn have been wetted previously.

In order to facilitate the complete and stable application, at the end of step g) a cotton rag, a palette knife, a rubberized roller (or the like) is preferably used to force out all the water that may be trapped under the image 101, which in fact by drying becomes anchored to the destination surface.

After having completed step g), and optionally the further activities described in the previous paragraph, the method 1 according to the disclosure entails, in a step h), removing the backing film 103 and the film 104, thus leaving only the image 101 on the destination surface and so completing the decoration.

In particular, it should be noted that after having completed step g), step h) is preferably carried out after having allowed the image 101 and the other components to dry (for 12-24 hours at ambient temperature, or for less time if forced drying in a kiln is used).

Similarly, after step h), the image 101 could be protected with an additional transparent patina (having first taken care to thoroughly clean the destination surface with an anti-silicone product).

As already said, the present disclosure (and of the protection claimed herein) provides a decal 100, which can be used for the decoration of a destination surface with a predefined image 101.

Preferably, the decal 100 will be obtained by carrying out (at least) steps from a) to d) of the method 1 according to the disclosure, but protection is also claimed for different embodiments which are still such as to confer on the decal 100 the structure described above and described again below.

The decal 100 therefore comprises a base sheet 102, which contains an adhesive.

Furthermore, the predefined decal 100 comprises a predefined image 101 reproduced on the base sheet 102.

Furthermore, the predefined decal 100 comprises a backing film 103, applied on the image 101 (and optionally, in part directly on the base sheet 102, if the image 101 and the base sheet 102 have different shapes and dimensions), for subsequently holding the correct positioning of the image 101.

According to the disclosure, the decal 100 comprises a further stiffening film 104, which is arranged so as to cover the backing film 103 and is adapted to increase the rigidity of the image 101 and/or of the backing film 103.

Whether it is obtained by way of the method 1 or otherwise, the decal 100 according to the disclosure comprises one or more of the various specifications described in the foregoing pages in relation to the method 1.

In particular therefore, the film 104 is made of a polymeric material, and preferably of a polymeric material selected from polyethylene, polyester, polyvinyl chloride and polyurethane.

Furthermore, in the preferred solution (which in any case does not limit the application of the disclosure) the base sheet 102 comprises a sheet of waterslide paper (although the possibility is not ruled out of using different materials, whether based on cellulose or otherwise) and the adhesive, which is constituted by dextrin.

With further reference to the preferred and non-exclusive solution, the backing film 103 is made of a collodion-based transparent material.

Protection is also claimed herein for the use of a decal 100 according to what is observed up to this point for the execution of a method 1 for decorating according to what is shown in the foregoing pages.

The execution of the method and the use of the decal are therefore evident from the foregoing description.

Steps from a) to d) of the method 1 according to the disclosure make it possible to provide a decal 100 bearing an image 101 that can subsequently be transferred and made to stably adhere to a destination surface to be decorated, by following steps from e) to h) of the method 1.

By virtue of the presence of the film 104, which covers the backing film 103 (by adhering to it), the latter (and the image 101) presents greater rigidity (and stability) than in conventional solutions. Such rigidity guards against the danger of deformations, stretches, creases or rips (or the like) during the delicate step g) of extracting the base sheet 102. This therefore makes it possible to carry out a method 1 for decorating surfaces while eliminating or at least appreciably reducing the risk of defects on the decoration obtained (on the image 101 that is made to adhere to the surface).

The presence of the film 104 and the stiffening obtained make it possible to entrust the task of carrying out the method 1 according to the disclosure even to personnel who is not specifically qualified or particularly careful, in that it is not necessary to observe particular precautions during step g).

Precisely the possibility of taking less care, than in conventional techniques, makes it possible to carry out the method 1 extremely rapidly and easily, thus achieving a result of undoubted practical interest, especially in the industrial sector and with a view to hold down costs.

It should be noted that the material chosen for the film 104 (whether it is polymeric or another type) is chosen conveniently, to ensure the rigidity described above while still ensuring the decal 100 has the necessary flexibility, in order to be capable of being applied on any destination surface, being able to effectively follow any curvature or corner edge thereof.

As for the method 1 therefore, the decal 100 also achieves the intended advantages, in that, by virtue of the film 104, it can be applied rapidly and easily on a destination surface, eliminating or at least appreciably reducing the risk of defects.

The method 1 and the decal 100 are therefore found to be extremely reliable, and they can be used for decorating any surface, including surfaces of large dimensions, while still ensuring extremely low costs and short implementation times.

The disclosure, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be substituted with other, different characteristics, existing in other embodiments.

In practice, the materials employed, as well as the dimensions, may be any according to requirements and to the state of the art.

The disclosures in Italian Patent Application No. 102018000004692 from which this application claims priority are incorporated herein by reference.

1.-10. (canceled)

11. A method for decorating a surface, in order to apply a predefined image to a destination surface, the method including the following steps:
a) preparing a base sheet, which contains an adhesive,
b) reproducing the predefined image on the base sheet,
c) applying a backing film to the predefined image, for a subsequent retention of a correct positioning of the image,
d) covering the backing film with an additional stiffening film, which is adapted to increase the rigidity of the predefined image and/or of the backing film, the assembly composed of the base sheet, the predefined image, the supporting film and the stiffening film defining a decal,
e) wetting the decal, in order to allow a transfer of the adhesive toward the predefined image,
f) applying the decal to the destination surface, by bringing the base sheet into contact with the destination surface,
g) sliding away the base sheet, while keeping the predefined image positioned on the destination surface, and
h) removing the backing film and the stiffening film.

12. The method according to claim 11, wherein the stiffening film is made of a polymeric material.

13. The method according to claim 12, wherein the stiffening film is made of a polymeric material selected from the group consisting of polyethylene, polyester, polyvinyl chloride, and polyurethane.

14. The method according to claim 11, wherein said step d) is obtained by hot or cold calendering.

15. The method according to claim 11, wherein said step b) is obtained by printing, more particularly by screen printing or lithography.

16. A decal for decorating a destination surface with a predefined image, which comprises:
a base sheet, which contains an adhesive,
a predefined image reproduced on said base sheet,
a backing film, applied to said predefined image, for a subsequent retention of a correct positioning of said predefined image,
and further comprising an additional stiffening film, which is arranged so as to cover said backing film and is adapted to increase the rigidity of said predefined image and/or of said backing film.

17. The decal according to claim 16, wherein said stiffening film is made of a polymeric material selected from the group consisting of polyethylene, polyester, polyvinyl chloride, and polyurethane.

18. The decal according to claim 16, wherein said base sheet comprises a sheet of paper of the waterslide type and said adhesive, which is constituted by dextrin.

19. The decal according to claim 16, wherein said backing film is made of a collodion-based transparent material.

20. Use of a decal comprising a base sheet, which contains an adhesive; a predefined image reproduced on said base sheet; a backing film, applied to said predefined image, for a subsequent retention of a correct positioning of said predefined image; and an additional stiffening film arranged to cover said backing film and is adapted to increase the rigidity of said predefined image and/or of said backing film, for carrying out a decoration method according to claim 11.
